(19) United States
(12) Patent Application Publication
(10) Pub. No.: US 2018/0046627 A1
(43) Pub. Date: Feb. 15, 2018

(54) PATTERN TRIGGERS WHILE SEARCHING AN INDEX OF DATA BEING INGESTED INTO A DISTRIBUTED COMPUTING SYSTEM

(71) Applicant: International Business Machines Corporation, Armonk, NY (US)

(72) Inventors: Wesley B. Leggette, Chicago, IL (US); Andrew D. Baptist, Mt. Pleasant, WI (US); Greg R. Dhuse, Chicago, IL (US); Jason K. Resch, Chicago, IL (US); Ilya Volvovski, Chicago, IL (US); Manish Motwani, Chicago, IL (US); S. Christopher Gladwin, Chicago, IL (US); Gary W. Grube, Barrington Hills, IL (US); Thomas F. Shirley, JR., Wauwatosa, WI (US)

(21) Appl. No.: 15/795,651

(22) Filed: Oct. 27, 2017

Related U.S. Application Data
(63) Continuation-in-part of application No. 15/405,203, filed on Jan. 12, 2017, now Pat. No. 9,817,701.
Application No. 15/405,203 is a continuation-in-part of application No. 13/865,641, filed on Apr. 18, 2013.
Application No. 13/865,641 is a continuation-in-part of application No. 13/707,490, filed on Dec. 6, 2012, now Pat. No. 9,304,857.
(60) Provisional application No. 61/569,387, filed on Dec. 12, 2011.

(51) Int. Cl. G06F 17/30

(52) U.S. Cl. CPC G06F 17/3051; G06F 17/30395; G06F 17/30283

(57) ABSTRACT

A storage unit (SU) includes an interface configured to interface and communicate with a dispersed storage network (DSN), a memory that stores operational instructions, and a processing module operably coupled to the interface and memory such that the processing module, when operable within the SU based on the operational instructions, is configured to perform various operations. The SU obtains a data index search request to search a data index and identifies a portion of the data index to search. The SU also identifies a DSN storage location corresponding to the portion of the data index and determines whether the DSN storage location is local. When the DSN storage location is not local, the SU generates a task request and transmits the task request to another SU associated with the DSN storage location. The SU then receives a result from the other SU based in response to the task request.

### CROSS REFERENCE TO RELATED PATENTS

The present U.S. Utility patent application claims priority pursuant to 35 U.S.C. §120, as a continuation-in-part (CIP) of U.S. Utility patent application Ser. No. 15/405,203, entitled “THRESHOLD COMPUTING IN A DISTRIBUTED COMPUTING SYSTEM,” filed Jan. 12, 2017, pending, which claims priority pursuant to 35 U.S.C. §120, as a continuation-in-part (CIP) of U.S. Utility patent application Ser. No. 13/865,641, entitled “DISPERSED STORAGE NETWORK SECURE HIERARCHICAL FILE DIRECTORY,” filed Apr. 18, 2013, pending, which claims priority pursuant to 35 U.S.C. §120, as a continuation-in-part (CIP) of U.S. Utility patent application Ser. No. 13/707,490, entitled “RETRIEVING DATA FROM A DISTRIBUTED STORAGE NETWORK,” filed Dec. 6, 2012, now issued as U.S. Pat. No. 9,304,857 on Apr. 5, 2016, which claims priority pursuant to 35 U.S.C. §119(e) to U.S. Provisional Application No. 61/569,387, entitled “DISTRIBUTED STORAGE AND TASK PROCESSING,” filed Dec. 12, 2011, now expired, all of which are hereby incorporated herein by reference in their entirety and made part of the present U.S. Utility patent application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

There exists significant room for improvement for searching and identification of information within prior art data storage systems. For example, when data is added to such a prior art data storage system, the overall system does not provide adequate means by which subsequent searching and identification of information within that prior art data storage system.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a diagram of an example of a distributed storage and task processing in accordance with the present invention;

FIG. 10 is a diagram of another example embodiment of a dispersed storage and task execution unit in accordance with the invention; and

FIG. 11 is a flowchart illustrating an example of searching a data index m accordance with the invention.

### DETAILED DESCRIPTION OF THE INVENTION

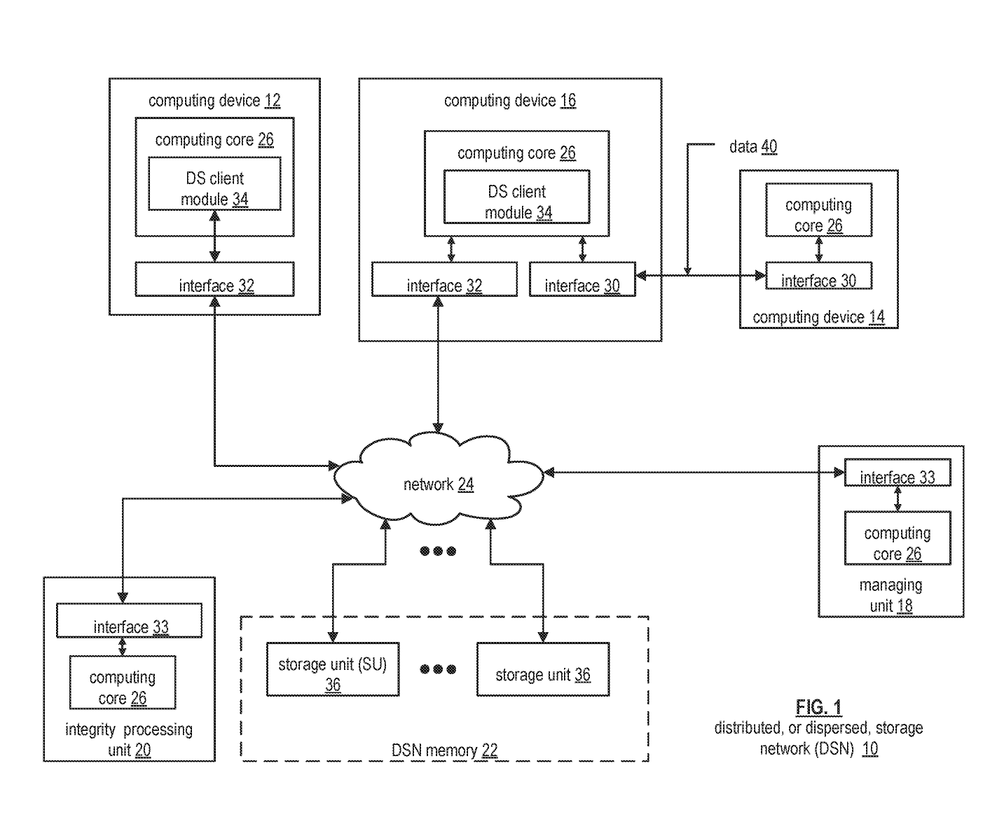

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

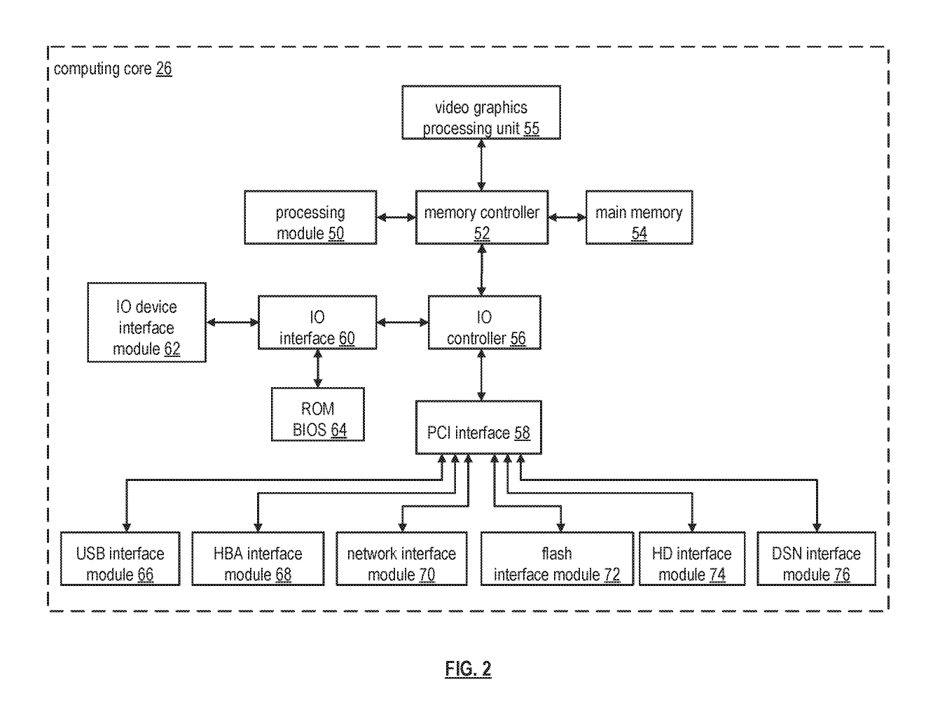

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

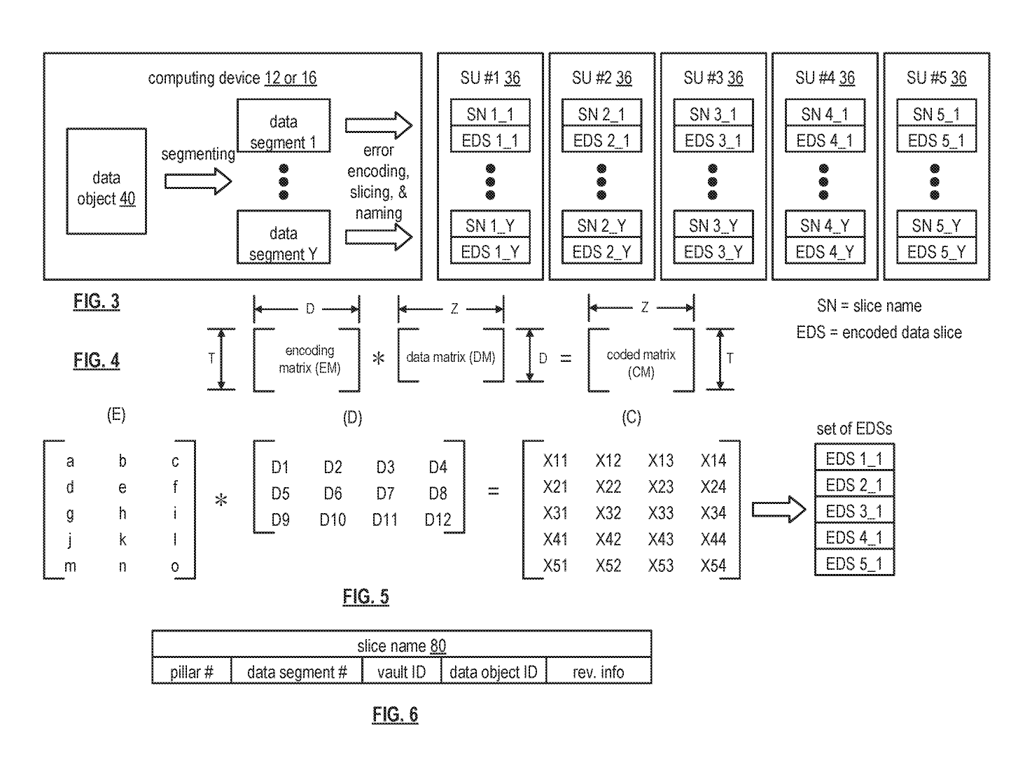

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN module 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSN managing unit 18 tracks the number of times a user accesses a non-public vault and/or public vaults, which can be used to generate a per-access billing information. In another instance, the DSN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

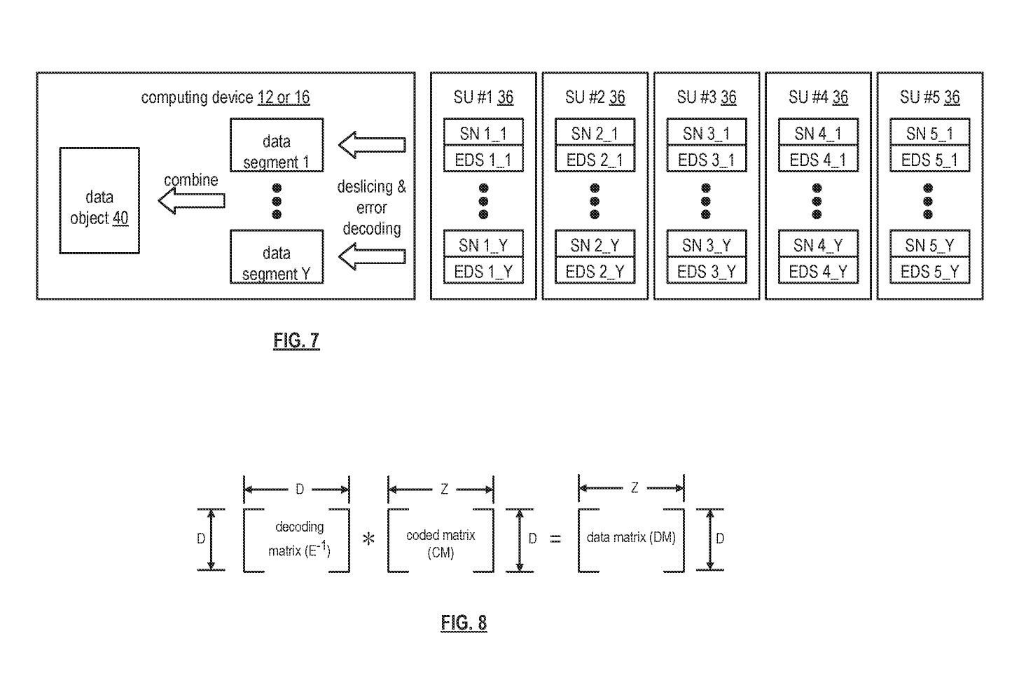

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 60 is shown in FIG. 6. As shown, the slice name (SN) 60 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

In some examples, note that dispersed or distributed storage network (DSN) memory includes one or more of a plurality of storage units (SUs) such as SUs 36 (e.g., that may alternatively be referred to a distributed storage and/or task network (DSTN) module that includes a plurality of distributed storage and/or task (DST) execution units 36 that may be located at geographically different sites (e.g., one in Chicago, one in Milwaukee, etc.). Each of the SUs (e.g., alternatively referred to as DST execution units in some examples) is operable to store dispersed error encoded data and/or to execute, in a distributed manner, one or more tasks on data. The tasks may be a simple function (e.g., a mathematical function, a logic function, an identify function, a find function, a search engine function, a replace function, etc.), a complex function (e.g., compression, human and/or computer language translation, text-to-voice conversion, voice-to-text conversion, etc.), multiple simple and/or complex functions, one or more algorithms, one or more applications, etc.

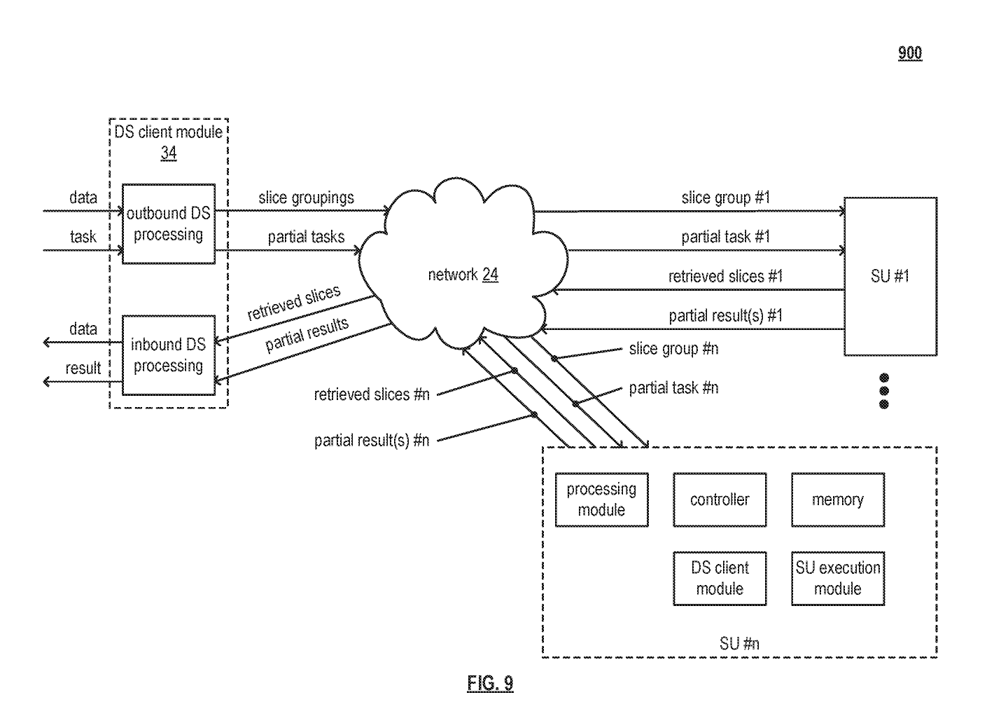

FIG. 9 is a diagram of an example 900 of a distributed storage and task processing in accordance with the present invention. This diagram includes an example 900 of a dispersed or distributed storage network (DSN) and/or distributed computing system performing a distributed storage and task processing operation. The distributed computing system includes a DS (distributed storage) client module (which may be in computing device 14 and/or in computing device 16 of FIG. 1), the network 24, a plurality of storage units (SUs) (which form at least a portion of the DSN memory 22, some alternative examples being SUs 36 shown in FIG. 1), the managing unit (not shown), and the integrity processing unit (not shown). The DS client module 34 includes an outbound DS processing section and an inbound DS processing section. Each of the SUs includes a controller, a processing module, memory, a SU execution module, and a DS client module.

In an example of operation, the DS client module 34 receives data and one or more tasks to be performed upon the data. The data may be of any size and of any content, where, due to the size (e.g., greater than a few Terra-Bytes), the content (e.g., secure data, etc.), and/or task(s) (e.g., MIPS intensive), distributed processing of the task(s) on the data is desired. For example, the data may be one or more digital books, a copy of a company's emails, a large-scale Internet search, a video security file, one or more entertainment video files (e.g., television programs, movies, etc.), data files, and/or any other large amount of data (e.g., greater than a few Terra-Bytes).

Within the DS client module 34, the outbound DS processing section receives the data and the task(s). The outbound DS processing section processes the data to produce slice groupings. As an example of such processing, the outbound DS partitions the data 25 into a plurality of data partitions. For each data partition, the outbound DS processing section dispersed storage (DS) error encodes it to produce encoded data slices and groups the encoded data slices into a slice grouping. In addition, the outbound DS processing section partitions the task into partial tasks, where the number of partial tasks may correspond to the number of slice groupings.

The outbound DS processing section then sends, via the network, the slice groupings and the partial task to the storage units (SUs) of the DSN memory 22. For example, the outbound DS processing section sends slice group 1 and partial task 1 to SU 1. As another example, the outbound DS processing section sends slice group #n and partial task #n to SU #n.

Each SU performs its partial task upon its slice group to produce partial results. For example, SU #1 performs partial task #1 on slice group #1 to produce a partial result #1, or results. As a more specific example, slice group #1 corresponds to a data partition of a series of digital books and the partial task #1 corresponds to searching for specific phrases, recording where the phrase is found, and establishing a phrase count. In this more specific example, the partial result #1 includes information as to where the phrase was found and includes the phrase count.

Upon completion of generating their respective partial results, the SUs send, via the network, they are partial results to the inbound DS processing section of the DS client module 34. The inbound DS processing section processes the received partial results to produce a result. Continuing with the specific example of the preceding paragraph, the inbound DS processing section combines the phrase count from each of the SUs to produce a total phrase count. In addition, the inbound DS processing section combines the ‘where the phrase was found’ information from each of the SUs within their respective data partitions to produce ‘where the phrase was found’ information for the series of digital books.

In another example of operation, the DS client module 34 requests retrieval of stored data within the memory of the SUs (e.g., memory of the DSN memory 22). In this example, the task is retrieve data stored in the memory of the DSN memory 22. Accordingly, the outbound DS processing section converts the task into a plurality of partial tasks and sends the partial tasks to the respective SUs.

In response to the partial task of retrieving stored data, a SU identifies the corresponding encoded data slices and retrieves them. For example, SU #1 receives partial task #1 and retrieves, in response thereto, retrieved slices #1. The SUs send their respective retrieved slices to the inbound DS processing section via the network.

The inbound DS processing section converts the received slices into data. For example, the inbound DS processing section de-groups the received slices to produce and coded slices per data partition. The inbound DS processing section then DS error 10 decodes the encoded slices per data partition to produce data partitions. The inbound DS processing section de-partitions the data partitions to recapture the data.

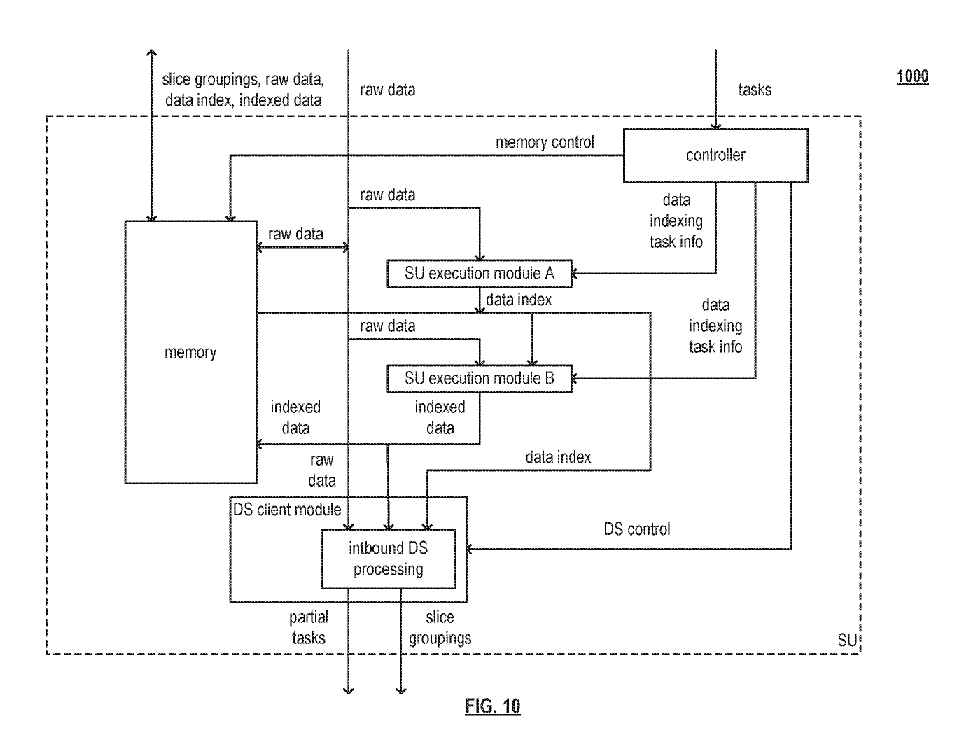

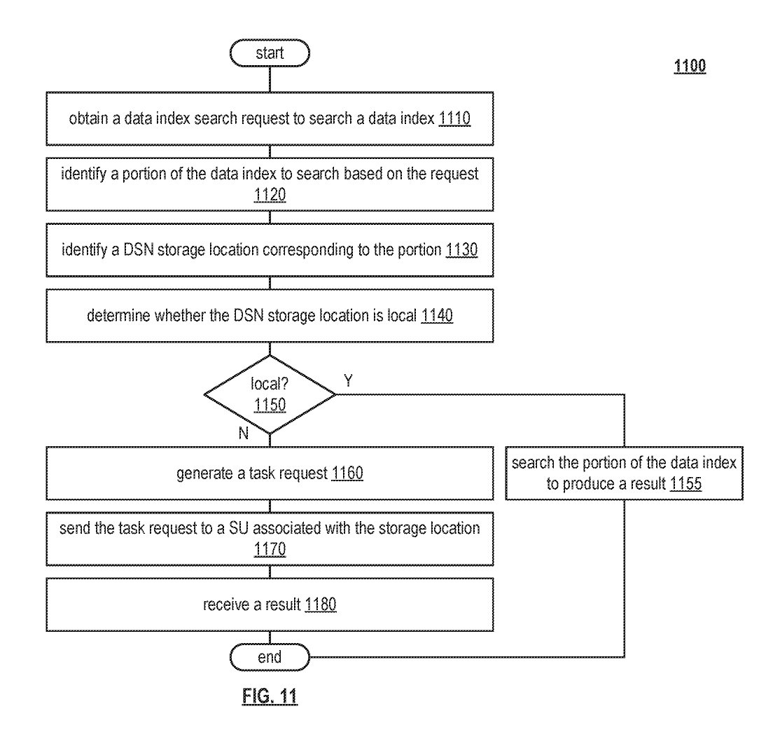

FIG. 10 is a diagram of another example 1000 embodiment of a storage unit (SU) in accordance with the invention. This diagram includes another example embodiment of a SU that includes a controller, a memory, a SU execution module A, a SU execution module B, and a distributed storage (DS) client module (e.g., see also an alternative example of a DS client module 34 implemented in computing device 12 or 16 such as shown in FIG. 1). The SU execution module A and SU execution module B may be implemented utilizing one or more modules. The DS client module includes at least one of an inbound DS processing and an outbound DS processing. The SU ingests raw data for storage and processing in accordance with a received task. Such a task includes one or more of a raw data search task and a partial task for execution on slices sent to the SU (e.g., storage and/or processing).

The controller produces control information based on the task to control one or more of the memory, SU execution module A, SU execution module B, and the DS client module. For example, the memory caches the raw data and SU execution module A processes the raw data in accordance with an index generation task information to produce a data index. The index generation task information includes one or more of a search parameter, a keyword, pattern recognition information, and timing information. The data index includes metadata of the raw data including one or more of keywords, dates, internet protocol addresses, partial content, word counts, statistics, a summary, a dispersed or distributed storage network (DSN) address corresponding to raw data storage, a DSN address corresponding to data index storage, and a DSN address corresponding to index data storage. The SU execution module B processes the raw data in accordance with data indexing task information to produce indexed data. The data indexing task information includes one or more of data reduction instructions, a keyword filter, a data index reference, and a indexed data format. Such indexed data includes a subset of the raw data organized in accordance with the data index.

The controller may control the memory with a memory control signal to facilitate caching one or more of the raw data, the data index, and the indexed data. The memory control signal may also facilitate the memory outputting one or more of the raw data, the data index, and the indexed data. The memory control signal may also facilitate the memory inputting slice groupings for caching in the memory further processing by SU execution module A and/or B.

The controller may output a DS control signal to the DS client module to facilitate the generation and outputting of one or more of slice groupings of the raw data, slice groupings of the data index, slice groupings of the indexed data, and one or more partial tasks. For example, the DS client module may send a portion of the slice groupings of the raw data to the memory of the SU for storage and send other portions of the slice groupings to other SUs for storage. As another example, the DS client module may generate slice groupings of the indexed data and send the slice groupings of indexed data to at least one other SU for further processing (e.g., a pattern search).

In an example of operation and implementation, a SU includes an interface configured to interface and communicate with a dispersed or distributed storage network (DSN), a memory that stores operational instructions, and a processing module operably coupled to the interface and memory such that the processing module, when operable within the SU based on the operational instructions, is configured to perform various operations. The processing module, when operable within the SU based on the operational instructions, is configured to perform one or more functions that may include generation of one or more signals, processing of one or more signals, receiving of one or more signals, transmission of one or more signals, interpreting of one or more signals, etc. and/or any other operations as described herein and/or their equivalents.

In an example of operation and implementation, the SU is configured to obtain a data index search request to search a data index. The SU is also configured to identify a portion of the data index to search based on the data index search request. In addition, the SU is configured to identify a DSN storage location corresponding to the portion of the data index. The SU is also configured to determine whether the DSN storage location is local based on at least one of a directory lookup, a query, or a memory map.

Based on an unfavorable local determination of the DSN storage location (e.g., when the DSN storage location is local such as local within the SU, local to a chassis that includes the SU, local within a building that includes the SU and/or one or more other SUs, local as determined to be within a particular geographical proximity such as within X meters where X is a positive number such as 1, 2, 5.3, 10.75, or another number, and/or based on some other basis for local or non-local determination), the SU is configured to generate a task request and to transmit the task request to another SU associated with the DSN storage location. After the other SU has generated a result based on the task request, the SU is configured to receive a result from the other SU based in response to the task request.

Alternatively, based on a favorable local determination of the DSN storage location (e.g., when the DSN storage location is not local such as not local within the SU, not local to a chassis that includes the SU, not local within a building that includes the SU and/or one or more other SUs, not local as determined to be within a particular geographical proximity such as within X meters where X is a positive number such as 1, 2, 5.3, 10.75, or another number, and/or based on some other basis for local or non-local determination), the SU is configured to search the portion of the data index to produce another result.

Note that the DS client module, the SU execution modules A and B, the controller, etc. may be implemented within various instantiations of a SU (e.g., such as any instantiations of SU 36) as described herein or their equivalents. For example, in some implementations, such a computing device includes an interface configured to interface and communicate with a dispersed or distributed storage network (DSN), memory that stores operational instructions. And a processing module operably coupled to the interface and to the memory. The processing module, when operable within the SU based on the operational instructions, is configured to perform one or more functions that may include generation of one or more signals, processing of one or more signals, receiving of one or more signals, transmission of one or more signals, interpreting of one or more signals, etc. and/or any other operations as described herein and/or their equivalents.

In some examples, the data index search request includes a data index identifier of the data index to search, one or more search terms, subsequent search terms for subsequent searches based on a search term match, and/or subsequent search terms for subsequent searches based on an unfavorable search term match. Also, in some other examples, the search terms include a trigger, a pattern, a value, a range, match criteria, and/or failure criteria.

Also, in certain other examples, the obtaining of the data index search to search the data index includes receiving the data index search, determining the data index search based on a previous data index search, a modification of a search term based on a previous result to obtain the data index search, a predetermination of the data index search, a query to obtain the data index search, and/or a list to obtain the data index search. Also, in certain particular examples, the identifying of the DSN storage location is based on the data index search request, a data index directory, execution resource availability, and/or a search timeframe requirement. In other examples, the generation of the task request is based on the data index search request, the portion of the data index to search, and/or the DSN storage location.

In addition, in some examples, note that the SU is configured to store at least one encoded data slices (EDSs) of a set of EDSs associated with a data object. In some examples, with respect to a data object, the data object is segmented into a plurality of data segments, and a data segment of the plurality of data segments is dispersed error encoded in accordance with dispersed error encoding parameters to produce a set of encoded data slices (EDSs). In some examples, the set of EDSs is of pillar width. Also, with respect to certain implementations, note that the decode threshold number of EDSs are needed to recover the data segment, and a read threshold number of EDSs provides for reconstruction of the data segment. Also, a write threshold number of EDSs provides for a successful transfer of the set of EDSs from a first at least one location in the DSN to a second at least one location in the DSN. The set of EDSs is of pillar width and includes a pillar number of EDSs. Also, in some examples, each of the decode threshold, the read threshold, and the write threshold is less than the pillar number. Also, in some particular examples, the write threshold number is greater than or equal to the read threshold number that is greater than or equal to the decode threshold number.

Note that the SU may be in communication with a computing device as described herein. In some examples, the SU is configured to receive the data index search from a computing device that includes at least one other SU of the plurality of SUs within the DSN, a wireless smart phone, a laptop, a tablet, a personal computers (PC), a work station, and/or a video game device. Note also that such a computing device may be located at a first premises that is remotely located from a second premises associated with at least one other computing device, at least one SU of a plurality of SUs within the DSN (e.g., such as a plurality of SUs that are implemented to store distributedly the set of EDSs), etc. In addition, note that such a computing device as described herein may be implemented as any of a number of different devices including a managing unit that is remotely located from another computing device within the DSN and/or SU within the DSN, an integrity processing unit that is remotely located from another computing device and/or SU within the DSN, and/or other device. Also, note that such a computing device as described herein may be of any of a variety of types of devices as described herein and/or their equivalents including a SU including a SU of any group and/or set of SUs within the DSN, a wireless smart phone, a laptop, a tablet, a personal computers (PC), a work station, and/or a video game device. Also, note also that the DSN may be implemented to include or be based on any of a number of different types of communication systems including a wireless communication system, a wire lined communication system, a non-public intranet system, a public internet system, a local area network (LAN), and/or a wide area network (WAN).

In another example of operation and implementation, the SU is configured to store at least one encoded data slices (EDSs) of a set of EDSs associated with a data object. Note that the data object is segmented into a plurality of data segments, and a data segment of the plurality of data segments is dispersed error encoded in accordance with dispersed error encoding parameters to produce the set of EDSs. Also, note that a decode threshold number of EDSs are needed to recover the data segment. The SU is configured to obtain a data index search request to search a data index and to identify a portion of the data index to search based on the data index search request. The SU is configured to identify a DSN storage location corresponding to the portion of the data index based on the data index search request, a data index directory, execution resource availability, and/or a search timeframe requirement. The SU is also configured to determine whether the DSN storage location is local based on a directory lookup, a query, and/or a memory map.

The SU is configured to search the portion of the data index to produce a result based on a favorable local determination of the DSN storage location (e.g., a determination that the DSN storage location is local). Alternatively, based on an unfavorable local determination of the DSN storage location, the SU is configured to generate a task request and to transmit the task request to another SU associated with the DSN storage location. After the other SU has generated a result based on the task request, the SU is configured to receive a result from the other SU based in response to the task request.

FIG. 11 is a flowchart illustrating an example of searching a data index m accordance with the invention. This diagram includes a flowchart illustrating an example of searching a data index. The method 1100 begins with the step 1110 where a processing module (e.g., of a storage unit (SU)) obtains a data index search request to search a data index. The data index search request includes one or more of a data index identifier of a data index to search, one or more search terms (e.g., a trigger, a pattern, a value, a range, match criteria, failure criteria), subsequent search terms for subsequent searches based on a search term match, and subsequent search terms for subsequent searches based on an unfavorable search term match. The obtaining includes one or more of receiving, determining based on a previous data index search (e.g., modify a search term based on a previous result), a predetermination, a query, and a list.

The method 1100 continues at the step 1120 where the processing module identifies a portion of the data index to search based on the request. The identifying may be based on one or more of the request, a data index directory (e.g., a mapping of major subsections of the data index), execution resource availability, and a search timeframe requirement. The method 1100 continues at the step 1130 where the processing module identifies a dispersed or distributed storage network (DSN) storage location corresponding to the portion. The storage location may include a local location (e.g., storage in a memory associated with a present SU) and one or more other SUs. The identifying may be based on one or more of the portion, a directory lookup, a query, and receiving storage location information.

The method 1100 continues at the step 1140 where the processing module determines whether the DSN storage location is local. The determining may be based on one or more of a directory lookup, a query, and a memory map. The method 1100 branches via the step 1150 to the step 1160 where the processing module generates a task request when the processing module determines that the DSN storage location is not local.

Alternatively, the method 1100 continues to the next step 1155 via the step 1150 when the processing module determines that the DSN storage location is local. The method 1100 continues at the next step 1155 where the processing module searches the portion of the data index to produce a result (e.g., executes a search task).

The method 1100 continues at the step 1160 where the processing module generates a task request. The generating is based on one or more of the data index search request, the portion of the data index to search, and the DSN storage location. For example, the processing module generates two task requests that include the search task and two DSN addresses corresponding to the DSN storage location at two SUs. The method 1100 continues at the step 1170 where the processing module sends the task request to a SU associated with the storage location. The method 1100 continues at the step 1180 where the processing module receives a result (e.g., from the SU associated with the storage location).

Alternative variants of the method 1100 operate by obtaining a data index search request to search a data index and identifying a portion of the data index to search based on the data index search request. Such variants of the method 1100 continue by identifying a DSN storage location corresponding to the portion of the data index and determining whether the DSN storage location is local based on at least one of a directory lookup, a query, or a memory map. Based on an unfavorable local determination of the DSN storage location, such variants of the method 1100 operate by generating a task request and transmitting (e.g., via an interface of the SU that is configured to interface and communicate with a dispersed or distributed storage network (DSN) that includes a plurality of storage units (SUs)) the task request to another SU associated with the DSN storage location and receiving (e.g., via the interface) a result from the another SU based in response to the task request. In addition, some alternative variants of the method 1100 operate by searching the portion of the data index to produce another result based on a favorable local determination of the DSN storage location.

This disclosure presents, among other things, a system, method, and/or device in which a data index search pattern is obtained. Such obtaining of a data may be based on one or more of generate based on an input pattern, receive, and/or modify a previous pattern based on a search result. In some examples, a cached data index is searched utilizing the data index search pattern (e.g., triggers, patterns, etc.) to produce a data index search result. Such a data index search result includes one or more of a trigger based match indicator, a trigger based match failure indicator, and/or a search summary.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A storage unit (SU) comprising:
an interface configured to interface and communicate with a dispersed or distributed storage network (DSN) that includes a plurality of storage units (SUs);
memory that stores operational instructions; and
a processing module operably coupled to the interface and to the memory, wherein the processing module, when operable within the SU based on the operational instructions, is configured to:
obtain a data index search request to search a data index;
identify a portion of the data index to search based on the data index search request;
identify a DSN storage location corresponding to the portion of the data index;
determine whether the DSN storage location is local based on at least one of a directory lookup, a query, or a memory map; and
based on an unfavorable local determination of the DSN storage location:
generate a task request;
transmit the task request to another SU associated with the DSN storage location; and
receive a result from the another SU based in response to the task request.

2. The SU of claim 1, wherein:
the data index search request includes at least one of a data index identifier of the data index to search, one or more search terms, subsequent search terms for subsequent searches based on a search term match, or subsequent search terms for subsequent searches based on an unfavorable search term match; and
the search terms include at least one of a trigger, a pattern, a value, a range, match criteria, or failure criteria.

3. The SU of claim 1, wherein obtaining of the data index search to search the data index includes at least one of receiving the data index search, determining the data index search based on at least one of a previous data index search, a modification of a search term based on a previous result to obtain the data index search, a predetermination of the data index search, a query to obtain the data index search, or a list to obtain the data index search.

4. The SU of claim 1, wherein identifying of the DSN storage location is based on at least one of the data index search request, a data index directory, execution resource availability, or a search timeframe requirement.

5. The SU of claim 1, wherein generation of the task request is based on at least one of the data index search request, the portion of the data index to search, or the DSN storage location.

6. The SU of claim 1, wherein the processing module, when operable within the SU based on the operational instructions, is further configured to:
store at least one encoded data slices (EDSs) of a set of EDSs associated with a data object; and
search the portion of the data index to produce another result based on a favorable local determination of the DSN storage location; and wherein:
the data object is segmented into a plurality of data segments;
a data segment of the plurality of data segments is dispersed error encoded in accordance with dispersed error encoding parameters to produce the set of EDSs;
a decode threshold number of EDSs are needed to recover the data segment;
a read threshold number of EDSs provides for reconstruction of the data segment;
a write threshold number of EDSs provides for a successful transfer of the set of EDSs from a first at least one location in the DSN to a second at least one location in the DSN;
the set of EDSs is of pillar width and includes a pillar number of EDSs;
each of the decode threshold number, the read threshold number, and the write threshold number is less than the pillar number; and
the write threshold number is greater than or equal to the read threshold number that is greater than or equal to the decode threshold number.

7. The SU of claim 1, wherein the processing module, when operable within the SU based on the operational instructions, is further configured to:
receive the data index search from a computing device that includes at least one other SU of the plurality of SUs within the DSN, a wireless smart phone, a laptop, a tablet, a personal computers (PC), a work station, or a video game device.

8. The SU of claim 1, wherein the DSN includes at least one of a wireless communication system, a wire lined communication system, a non-public intranet system, a public internet system, a local area network (LAN), or a wide area network (WAN).

9. A storage unit (SU) comprising:
an interface configured to interface and communicate with a dispersed or distributed storage network (DSN) that includes a plurality of storage units (SUs);
memory that stores operational instructions; and
a processing module operably coupled to the interface and to the memory, wherein the processing module, when operable within the SU based on the operational instructions, is configured to:
store at least one encoded data slices (EDSs) of a set of EDSs associated with a data object, wherein the data object is segmented into a plurality of data segments, wherein a data segment of the plurality of data segments is dispersed error encoded in accordance with dispersed error encoding parameters to produce the set of EDSs, and wherein a decode threshold number of EDSs are needed to recover the data segment;
obtain a data index search request to search a data index;
identify a portion of the data index to search based on the data index search request;
identify a DSN storage location corresponding to the portion of the data index based on at least one of the data index search request, a data index directory, execution resource availability, or a search timeframe requirement;
determine whether the DSN storage location is local based on at least one of a directory lookup, a query, or a memory map; and
search the portion of the data index to produce a result based on a favorable local determination of the DSN storage location;
based on an unfavorable local determination of the DSN storage location:
generate a task request;
transmit the task request to another SU associated with the DSN storage location; and
receive another result from the another SU based in response to the task request.

10. The SU of claim 9, wherein:
the data index search request includes at least one of a data index identifier of the data index to search, one or more search terms, subsequent search terms for subsequent searches based on a search term match, or subsequent search terms for subsequent searches based on an unfavorable search term match; and
the search terms include at least one of a trigger, a pattern, a value, a range, match criteria, or failure criteria.

11. The SU of claim 9, wherein obtaining of the data index search to search the data index includes at least one of receiving the data index search, determining the data index search based on at least one of a previous data index search, a modification of a search term based on a previous result to obtain the data index search, a predetermination of the data index search, a query to obtain the data index search, or a list to obtain the data index search.

12. The SU of claim 9, wherein:
a read threshold number of EDSs provides for reconstruction of the data segment;
a write threshold number of EDSs provides for a successful transfer of the set of EDSs from a first at least one location in the DSN to a second at least one location in the DSN;
the set of EDSs is of pillar width and includes a pillar number of EDSs;
each of the decode threshold number, the read threshold number, and the write threshold number is less than the pillar number; and
the write threshold number is greater than or equal to the read threshold number that is greater than or equal to the decode threshold number.

13. The SU of claim 9, wherein:
the SU is located at a first premises that is remotely located from at least one other SU of the plurality of SUs within the DSN; and
the DSN includes at least one of a wireless communication system, a wire lined communication system, a non-public intranet system, a public internet system, a local area network (LAN), or a wide area network (WAN).

14. A method for execution by a storage unit (SU), the method comprising:
obtaining a data index search request to search a data index;
identifying a portion of the data index to search based on the data index search request;
identifying a DSN storage location corresponding to the portion of the data index;
determining whether the DSN storage location is local based on at least one of a directory lookup, a query, or a memory map; and
based on an unfavorable local determination of the DSN storage location:
generating a task request;
transmitting, via an interface of the SU that is configured to interface and communicate with a dispersed or distributed storage network (DSN) that includes a plurality of storage units (SUs), the task request to another SU associated with the DSN storage location; and
receiving, via the interface, a result from the another SU based in response to the task request.

15. The method of claim 14, wherein:
the data index search request includes at least one of a data index identifier of the data index to search, one or more search terms, subsequent search terms for subsequent searches based on a search term match, or subsequent search terms for subsequent searches based on an unfavorable search term match; and
the search terms include at least one of a trigger, a pattern, a value, a range, match criteria, or failure criteria.

16. The method of claim 14, wherein obtaining of the data index search to search the data index includes at least one of receiving the data index search, determining the data index search based on at least one of a previous data index search, a modification of a search term based on a previous result to obtain the data index search, a predetermination of the data index search, a query to obtain the data index search, or a list to obtain the data index search.

17. The method of claim 14, wherein identifying of the DSN storage location is based on at least one of the data index search request, a data index directory, execution resource availability, or a search timeframe requirement.

18. The method of claim 14, wherein generation of the task request is based on at least one of the data index search request, the portion of the data index to search, or the DSN storage location.

19. The method of claim 14 further comprising:
storing at least one encoded data slices (EDSs) of a set of EDSs associated with a data object; and
searching the portion of the data index to produce another result based on a favorable local determination of the DSN storage location; and wherein:
the data object is segmented into a plurality of data segments;
a data segment of the plurality of data segments is dispersed error encoded in accordance with dispersed error encoding parameters to produce the set of EDSs;
a decode threshold number of EDSs are needed to recover the data segment;
a read threshold number of EDSs provides for reconstruction of the data segment;
a write threshold number of EDSs provides for a successful transfer of the set of EDSs from a first at least one location in the DSN to a second at least one location in the DSN;
the set of EDSs is of pillar width and includes a pillar number of EDSs;
each of the decode threshold number, the read threshold number, and the write threshold number is less than the pillar number; and
the write threshold number is greater than or equal to the read threshold number that is greater than or equal to the decode threshold number.

20. The method of claim 14 further comprising receiving the data index search from a computing device that includes at least one other SU of the plurality of SUs within the DSN, a wireless smart phone, a laptop, a tablet, a personal computers (PC), a work station, or a video game device; and wherein the DSN includes at least one of a wireless communication system, a wire lined communication system, a non-public intranet system, a public internet system, a local area network (LAN), or a wide area network (WAN).
